(19) United States
(12) Patent Application Publication
(10) Pub. No.: US 2009/0123650 A1
(43) Pub. Date: May 14, 2009

(54) METHOD FOR PRODUCING RESIN-COATED SLIDING MEMBER AND APPARATUS FOR PRODUCING THE SAME

(75) Inventors: Hideki IWATA, Inuyama (JP); Toshihiko Takagi, Inuyama (JP)

Correspondence Address: BROWDY AND NEIMARK, P.L.L.C.;624 NINTH STREET, NW, SUITE 300, WASHINGTON, DC, 20001-5303, US

(73) Assignee: DAIDO METAL COMPANY LTD., Nagoya (JP)

(21) Appl. No.: 12/264,108

(22) Filed: Nov. 3, 2008

(30) Foreign Application Priority Data
Nov. 2, 2007 (JP) 2007285700

(51) Int. Cl. B05D 3/02

(52) U.S. Cl. 427/294; 118/61; 427/385.5; 427/379

(57) ABSTRACT

An object of the present invention is to provide a method for producing a resin-coated sliding member wherein the method ensures the productivity and at the same time enables the recycling of the solvent so as to be friendly to the environment. According to the present invention, included are a coating step in which a porous sintered layer prepared by sintering on a back metal is impregnated with a solvent-containing resin composition, a heating step to heat the solvent and the resin composition and a collecting step to collect the solvent wherein the vaporized solvent is sucked, liquefied and collected; and hence even when a solvent having a high boiling point and a low vapor pressure is used, the solvent can be collected efficiently by applying a low energy, and the collected solvent is recycled so as to be friendly to the environment and to enable the reduction of the consumed raw materials.

### BACKGROUND OF THE INVENTION

(1) Field of the Invention

The present invention relates to a method for producing a resin-coated sliding member by a process in which a solvent-containing resin composition is applied to a back metal, or the solvent-containing resin composition is impregnated in a porous sintered portion prepared by sintering on the back metal, thereafter the solvent is vaporized by heating (drying of the solvent-containing resin composition) and the thus treated resin composition is baked, and relates to an apparatus for producing the resin-coated sliding member.

(2) Description of related art

Resin-coated sliding members have hitherto been produced by impregnating and coating a back metal made of steel (band steel) having a sintered layer of a powder such as a copper powder or a bronze powder with a solvent (for example toluene)-containing resin composition composed of a resin such as PTFE (polytetrafluoroethylene) or PAI (polyamide-imide), and by thereafter drying and baking the resin composition (JP-A-2002-522593). In the production of such resin-coated sliding members, the addition of a solvent to the resin composition is essential for the viscosity regulation, and for the impregnation property (facility of impregnation) and the like of the resin composition, and consequently, the drying step before the baking has been inevitable. However, the solvent generated as vapor at the time of drying has been subjected to disposal such as releasing in the air or combustion.

However, if a solvent such as toluene is collected as a gas (in a vapor state, or in a vaporized state), the vapor pressure of toluene itself is high, and hence the vapor easily dissolves in the air to degrade the collection rate of toluene; alternatively, even if the collection is successful, the boiling point of toluene is low, and hence a large-scale cooling apparatus is needed for cooling from the temperature at which the solvent is dried, down to the boiling point of the solvent to cause condensation of the solvent. Another possible technique is such that a vacuum atmosphere is prepared and in such an atmosphere the solvent is dried and collected; however, the continuous molding as applied in the production of sliding members is hardly compatible with maintenance of vacuum, and hence such a technique is hardly applicable.

Alternatively, if the productivity is intended to be improved by enhancing the drying ability (facility of drying), it is necessary to select a solvent having a high vapor pressure and a low boiling point; however, such a solvent can be said to be a solvent difficult to collect. The solvent generated as the vapor at the time of drying has been subjected to disposal such as releasing in the air or combustion, and is associated with the environmental issues such as the atmospheric pollution or the increase of carbon dioxide in the atmosphere. Accordingly, the drying ability (the quick-drying ability of the solvent) or the productivity has been incompatible with the easiness in collecting the vaporized solvent.

Improvement of the productivity by enhancing the drying ability of the solvent has caused a problem that the collection of the vaporized solvent is made difficult and the environmental issues are adversely affected. The present invention has been conducted in view of the above-described circumstances, and an object of the present invention is to provide a method for producing a resin-coated sliding member wherein the method ensures the productivity and at the same time enables the recycling of the solvent so as to be friendly to the environment, and to provide an apparatus for producing the resin-coated sliding member.

### SUMMARY OF THE INVENTION

For the purpose of achieving the above-described object, the present invention provides a method for producing a resin-coated sliding member by the process in which a solvent-containing resin composition is applied to a back metal and thereafter the solvent is vaporized by heating, or the solvent-containing resin composition is impregnated in a porous sintered portion prepared by sintering on the back metal, thereafter the solvent is vaporized by heating, and the thus treated resin composition is baked, wherein the method includes steps of: coating the back metal wherein the solvent-containing resin composition is applied to the back metal or impregnated in the porous sintered portion prepared by sintering on the back metal; heating the solvent and the resin composition; and collecting the solvent wherein the solvent vaporized in the heating step is sucked and liquefied, and the liquefied solvent is collected.

In the present invention, preferably, the heating step includes a first heating step and a second heating step, wherein the processing temperature of the second heating step is higher than the processing temperature of the first heating step, and the processing temperature of the first heating step is not lower than the boiling point of the solvent and the processing temperature of the second step is not lower than the melting point of the main constituent component of the resin composition and not higher than the decomposition temperature of the main constituent component of the resin composition. It is to be noted that in the present invention, the processing temperature means the temperature in the resin composition and the highest temperature in the concerned step.

It is to be noted herein that the collecting step, in principle, vaporizes the solvent in the first heating step, immediately subsequently sucks and liquefies the vaporized solvent, and the liquefied solvent is collected; when the solvent is also vaporized in the second heating step higher in processing temperature than the first heating step, the solvent vapor generated in the second heating step may be sucked and liquefied, and the liquefied solvent may be collected. Alternatively, the collection of the solvent may be conducted either only in the first heating step or only in the second heating step. It is to be noted that when a resin-coated sliding member is produced by continuous molding, the heating step including the first heating step and the second heating step and the collecting step are practically conducted at the same time.

In the present invention, it is also preferable to conduct a rapid heating in the first heating step and/or the second heating step.

Here, examples of the above-described heating step include: a method in which the frequencies of the electromagnetic waves of the infrared ray generated from a light source such as a halogen lamp are made to resonate with the frequencies of the molecular structure constituting the solvent, and thus, the temperature of the solvent itself is increased to rapidly vaporize the solvent; and a method in which an induction current is made to flow through the back metal by making a magnetic flux penetrate into the back metal coated with the solvent-containing resin composition, as in high-frequency induction heating, thus a rapid heating is conducted by generating the Joule heat due to the electric resistance of the back metal, and the solvent is rapidly vaporized by the heat transfer from the back metal. The vaporization in a short time through rapid heating can be conducted successfully with a small size furnace, consequently a small volume of gas is required to be sucked, and hence the vaporized solvent in the furnace can be efficiently collected. It is to be noted herein that the temperature increase at the time of the rapid heating is preferably conducted in such a way that the resin composition is heated within 20 seconds to a temperature not lower than the melting point of the main constituent component of the resin composition and not higher than the decomposition temperature of the main constituent component of the resin composition. The temperature increase rate of the solvent for rapid vaporization is the larger the better, is assumed to be not less than 10° C./sec, usually set within a range from 10 to 1400° C./sec, and preferably within a range from 20 to 400° C./sec. In this case, the temperature increase rate of the resin composition or the back metal is set within a range from 20 to 100° C./sec. Additionally, it is preferable to conduct the rapid heating only in the first heating step from the viewpoint of the production of a resin-coated sliding member.

In the present invention, a solvent having a boiling point of not lower than 150° C. is also preferably used as the solvent added to the resin composition.

In this connection, conventionally, as described above, a solvent low in boiling point and easily vaporizable has been used for the purpose of improving the productivity. Even if the vaporized solvent has been able to be collected, it is necessary to forcibly cool the gaseous solvent down to a temperature of not higher than the boiling point for dropwise condensation of the gaseous solvent. In the present invention, by daringly selecting a hardly vaporizable solvent having a high boiling point, the gaseous solvent is preferably collected while the solvent is being vaporized or preferably rapidly vaporized. When the boiling point of the solvent collected in a gaseous state is high, the gaseous solvent can be easily reach the dropwise condensation temperature, thus the energy consumed for cooling can be reduced, and the collection as liquid is facilitated.

In the present invention, a solvent having a vapor pressure of not more than 0.5 kPa at room temperature is also preferably used.

It is to be noted herein that the vapor pressure means the pressure of the vapor wherein the gas is in equilibrium with the liquid state or the solid state. With the decrease of the vapor pressure of the collected solvent, the amount of the collected solvent dissolving in the air is decreased, the collected solvent tends to be easily condensed dropwise, and the amount of the vapor (gaseous solvent) to be converted into liquid is increased.

Further, in the present invention, the boiling point of the solvent is preferably not lower than 150° C. and the vapor pressure of the solvent is preferably not more than 0.5 kPa at room temperature.

As described above, when the solvent has a high boiling point and a vapor pressure at room temperature of not more than 0.5 kPa, the solvent is easily condensed dropwise (become liquefied) and easily collected as liquid.

The present invention also provides an apparatus for producing a resin-coated sliding member by a process in which a solvent-containing resin composition is applied to a back metal and thereafter the solvent is vaporized by heating, or the solvent-containing resin composition is impregnated in a porous sintered portion prepared by sintering on the back metal, and thereafter the solvent is vaporized by heating, and the thus treated resin composition is baked, wherein the apparatus comprises: a heating unit to heat the solvent and the resin composition; and a collecting unit to collect the solvent wherein the solvent vaporized in the heating step is sucked and liquefied, and the liquefied solvent is collected.

In the present invention, the collecting step is provided in the production of the resin-coated sliding member, and consequently there can be realized a method for producing a resin-coated sliding member wherein the method ensures the productivity of the resin-coated sliding member and at the same time enables the recycling of the solvent so as to be friendly to the environment. Even in a continuous molding such as the production of a resin-coated sliding member, the collection of the solvent can be properly conducted. Consequently, there can be realized a method for producing a resin-coated sliding member wherein the method ensures the productivity and at the same time enables the recycling of the solvent so as to be friendly to the environment.

In the present invention, the heating step includes the first heating step and the second heating step; the processing temperature of the second heating step is higher than the processing temperature of the first heating step, and the processing temperature of the first heating step is not lower than the boiling point of the solvent and the processing temperature of the second heating step is not lower than the melting point of the main constituent component of the resin composition and not higher than the decomposition temperature of the main constituent component of the resin composition; consequently, most of the solvent can be vaporized in the first heating step, and the baking of the resin composition can be conducted without fail in the second heating step. It is to be noted herein that as the resin composition, PTFE, PEEK (polyetheretherketone), PI (polyimide), PAI, PES polyethylene sulfide), PPS (polyphenylene sulfide), POM (polyoxymethylene) and the like can be used, and PTFE is particularly preferably used.

In the present invention, rapid heating is preferably conducted because the solvent can be efficiently vaporized. When the temperature increase rate of the resin composition is 20 to 100° C./sec, the solvent can be most efficiently vaporized. The collection of the solvent is conducted in the collecting step at the time of rapid heating, and hence the solvent efficiently vaporized in a furnace shorter than conventionally, namely, in a smaller volume than conventionally can be collected efficiently.

In the present invention, when a solvent having a high boiling point is used, the collected gaseous solvent is condensed dropwise without consuming a huge amount of energy for cooling, thus the collected gaseous solvent is liquefied and the collection of the solvent as liquid can be facilitated.

In the present invention, when a solvent having a low vapor pressure of not more than 0.5 kPa at room temperature is used, the collected gaseous solvent does not dissolve in the air and is liquefied, and the collection of the solvent as liquid can be facilitated.

In the present invention, when a solvent having a boiling point of not lower than 150° C. and a vapor pressure of not more than 0.5 kPa at room temperature is used, the cooling does not consume a huge amount of energy, the collected gaseous solvent does not dissolve in the air and is liquefied, and the efficient collection of the solvent as liquid can be facilitated.

According to the present invention, the resin-coated sliding member can be produced while the productivity is being ensured and at the same time the recycling of the solvent is being enabled, and hence the resin-coated sliding member can be produced in a manner friendly to the environment.

### BRIEF DESCRIPTION OF DRAWING

FIG. 1 is a schematic view illustrating the production steps of the resin-coated sliding member according to an embodiment.

### DESCRIPTION OF REFERENCE NUMERALS

10 Uncoiler
11 Back metal
12 Resin impregnation unit
13 Drying furnace
14 Collecting unit
15 Baking furnace
16 Cooling zone
17 Coiler

### DESCRIPTION OF PREFERRED EMBODIMENT

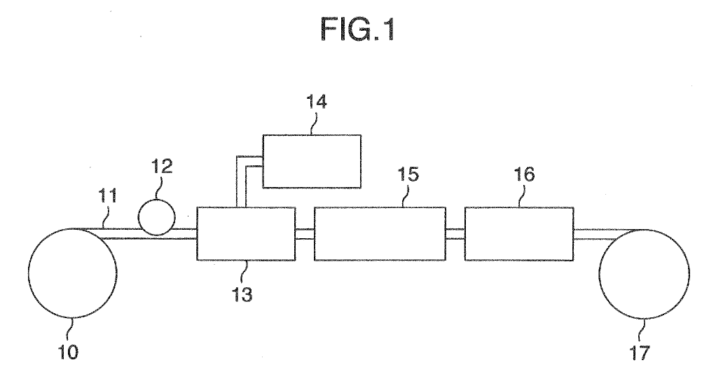

Hereinafter, the embodiment of the present invention is described. FIG. 1 is a schematic view illustrating the production steps of the resin-coated sliding member according to the embodiment.

In FIG. 1, a back metal 11 having a porous sintered layer delivered from an uncoiler 10 is impregnated with a solvent-containing resin composition by using a resin impregnation unit 12 (coating step). Thereafter, by heating with a drying furnace (a first heating furnace) 13 having in the interior thereof an electromagnetic wave oscillation source emitting infrared ray, the solvent is vaporized (gasified) at a processing temperature of 200° C. and at a temperature increase rate of 30° C./sec (the resin composition) to dry the resin composition (a drying step (a first heating step)). The vaporized solvent in the drying step is sucked by a collecting unit 14 communicatively connected to the drying furnace 13, to be liquefied and collected (collecting step). The back metal having a porous sintered layer, in the present embodiment, was obtained, for example, as follows: a copper alloy powder was put in a thickness of 0.3 mm on a 1.2 mm thick steel plate (back metal), then heated at a temperature of 750 to 900° C. in a reductive atmosphere to sinter the copper alloy powder to prepare the back metal having a porous sintered layer. In the above-described coating step, the back metal 11 having a porous sintered layer delivered from the uncoiler 10 is impregnated with the solvent-containing resin composition by using a resin impregnation unit 12; however, alternatively the back metal 11 delivered from the uncoiler 10 may be coated with the solvent-containing resin composition by using the resin impregnation unit 12.

In the above-described drying step, a halogen lamp is used as the infrared ray oscillation source disposed inside the drying furnace 13. Specifically, the solvents such as isoparaffins belonging to hydrocarbons, alcohols and fatty acids are involved, and the resin is PTFE. As the drying (heating) device other than the halogen lamp, a lamp such as a xenon lamp, a xenon flash lamp or a mercury lamp, or a high-frequency induction heating device may also be used.

In the above-described collecting step, the vapor of the solvent and the air present in the drying furnace 13 are sucked from the drying furnace 13 in such a way that the concentration of the solvent being used does not reach the limit of explosion. The sucked mixture is cooled with a cooling device in the collecting unit 14 to liquefy the vapor of the solvent to be collected as liquid. It is to be noted that the cooling device is not necessarily needed.

Again with reference to FIG. 1, next to the above-described drying step, in order to bake the dried resin composition, baking is conducted by heating with a baking furnace (second heating furnace) 15 at a processing temperature of 370° C. at a temperature increase rate (the resin composition) of 10° C./sec (baking step (second heating step)). In this baking step, when a PTFE resin is used, baking is conducted at a temperature not lower than the melting point and lower than the decomposition temperature of the PTFE resin; when a thermosetting resin is used, the baking is conducted at a temperature not lower than the curing initiation temperature. From the viewpoint of the configuration involving the baking furnace 15, a high-frequency induction heating furnace, an electric furnace or a gas furnace may be adopted as the baking furnace 15. When the baking furnace 15 is a high-frequency induction heating furnace, the collecting unit 14 is preferably communicatively connected to the baking furnace 15. When the baking furnace 15 is an electric furnace or a gas furnace, the collecting unit 14 is preferably communicatively connected to the drying furnace 13 as shown in FIG. 1.

Next to the baking step, the baked resin-coated back metal is cooled down to room temperature in a cooling zone 16, and thereafter taken up with a coiler 17. The cooling in the cooling zone 16 may be a cooling capable of cooling down to room temperature by air cooling or water cooling, or a combination of these. Between the cooling zone 16 and the coiler 17, a sizing step for controlling the total thickness of the resin-coated back metal may be interposed.

The embodiment of the present invention has been described above. In the above-described embodiment, a PTFE resin is presented as the resin composition, but PEEK, PI, PAI, PES, PPS, POM or the like, other than PTFE, may also be adopted. The back metal may be made of various metals, various alloys or the like other than steel. Further, solid lubricants such as MoS₂ and graphite, hard particles and the like may be used as mixed in the resin.

1. A method for producing a resin-coated sliding member by a process in which a solvent-containing resin composition is applied to a back metal and thereafter the solvent is vaporized by heating, or the solvent-containing resin composition is impregnated in a porous sintered portion prepared by sintering on the back metal and thereafter the solvent is vaporized by heating, and the thus treated resin composition is baked,
wherein the method comprises steps of:
coating the back metal wherein the solvent-containing resin composition is applied to the back metal or impregnated in the porous sintered portion prepared by sintering on the back metal;
heating the solvent and the resin composition; and
collecting the solvent wherein the solvent vaporized in the heating step is sucked and liquefied, and the liquefied solvent is collected.

2. The method for producing a resin-coated sliding member according to claim 1, wherein the heating step comprises a first heating step and a second heating step, wherein:
a processing temperature of the second heating step is higher than a processing temperature of the first heating step; and
the processing temperature of the first heating step is not lower than a boiling point of the solvent and the processing temperature of the second heating step is not lower than a melting point of a main constituent component of the resin composition and not higher than a decomposition temperature of the main constituent component of the resin composition.

3. The method for producing a resin-coated sliding member according to claim 2, wherein the first heating step and/or the second heating step conducts a rapid heating.

4. The method for producing a resin-coated sliding member according to claim 1, wherein the boiling point of the solvent is not lower than 150° C.

5. The method for producing a resin-coated sliding member according to claim 2, wherein the boiling point of the solvent is not lower than 150° C.

6. The method for producing a resin-coated sliding member according to claim 3, wherein the boiling point of the solvent is not lower than 150° C.

7. The method for producing a resin-coated sliding member according to claim 1, wherein a vapor pressure of the solvent is not more than 0.5 kPa at room temperature.

8. The method for producing a resin-coated sliding member according to claim 2, wherein a vapor pressure of the solvent is not more than 0.5 kPa at room temperature.

9. The method for producing a resin-coated sliding member according to claim 3, wherein a vapor pressure of the solvent is not more than 0.5 kPa at room temperature.

10. The method for producing a resin-coated sliding member according to claim 1, wherein the boiling point of the solvent is not lower than 150° C. and the vapor pressure of the solvent is not more than 0.5 kPa at room temperature.

11. The method for producing a resin-coated sliding member according to claim 2, wherein the boiling point of the solvent is not lower than 150° C. and the vapor pressure of the solvent is not more than 0.5 kPa at room temperature.

12. The method for producing a resin-coated sliding member according to claim 3, wherein the boiling point of the solvent is not lower than 150° C. and the vapor pressure of the solvent is not more than 0.5 kPa at room temperature.

13. An apparatus for producing a resin-coated sliding member by a process in which a solvent-containing resin composition is applied to a back metal and thereafter the solvent is vaporized by heating, or the solvent-containing resin composition is impregnated in a porous sintered portion prepared by sintering on the back metal and thereafter the solvent is vaporized by heating, and the thus treated resin composition is baked,
wherein the apparatus comprises:
a heating unit to heat the solvent and the resin composition; and
a collecting unit to collect the solvent wherein the solvent vaporized in the heating step is sucked and liquefied, and the liquefied solvent is collected.

14. The apparatus for producing a resin-coated sliding member according to claim 13, wherein the boiling point of the solvent is not lower than 150° C.

15. The method for producing a resin-coated sliding member according claim 13, wherein a vapor pressure of the solvent is not more than 0.5 kPa at room temperature.

16. The apparatus for producing a resin-coated sliding member according to claim 13, wherein the boiling point of the solvent is not lower than 150° C. and the vapor pressure of the solvent is not more than 0.5 kPa at room temperature.
